(19) United States
(12) Patent Application Publication
(10) Pub. No.: US 2025/0383932 A1
(43) Pub. Date: Dec. 18, 2025

(54) ELECTRONIC DEVICE AND METHOD FOR SCHEDULING THREADS

(71) Applicant: MEDIATEK INC., Hsinchu City (TW)

(72) Inventors: Chuang-Yin WANG, Hsinchu City (TW); Chung-Hao HO, Hsinchu City (TW); Hao-Kai LEE, Hsinchu City (TW); Tsung-Yu TSAI, Hsinchu City (TW); Cheng-Han TSAI, Hsinchu City (TW); Cheng-Che CHEN, Hsinchu City (TW)

(21) Appl. No.: 19/189,380

(22) Filed: Apr. 25, 2025

Related U.S. Application Data
(60) Provisional application No. 63/658,943, filed on Jun. 12, 2024.

(51) Int. Cl. G06F 9/50

(52) U.S. Cl. CPC G06F 9/505; G06F 9/5044; G06F 2209/5018; G06F 2209/5022

(57) ABSTRACT

An electronic device is provided. The electronic device includes a memory storing a program instruction and a central processing unit (CPU) with a first core and a second core. The computing power of the first core is higher than the computing power of the second core. The CPU is configured to read and execute the program instruction to implement a scheduler, a policy hint module, and an application. The CPU is further configured to calculate the required computing power of a thread of the application. When the required computing power of the thread is higher than a threshold, the policy hint module is configured to transmit a message to the scheduler, and the message indicates that the thread has to be allocated to the first core.

### CROSS REFERENCE TO RELATED APPLICATIONS

This application claims priority of U.S. Provisional Application Ser. No. 63/658,943, filed on 2024 Jun. 12, the entirety of which is incorporated by reference herein.

### BACKGROUND OF THE INVENTION

### Field of the Invention

The present invention relates to the scheduling of threads, and, in particular, it relates to scheduling threads based on the required computing power of the thread.

### Description of the Related Art

To improve user experience, electronic devices have to maintain high performance, but they also have to maintain the proper power consumption and temperature at the same time. This requires the devices to allocate resources precisely. There are some known algorithms for the CPU scheduling and core selection. However, these algorithms are not satisfactory in every respect. For example, these algorithms do not take the information of the application, such as the frame rate and the latency requirement of the thread, into consideration. Developers still have to manually adjust the resource allocation policy for different applications and platforms.

Thus, a mechanism for scheduling the threads to solve the aforementioned problems is required.

### BRIEF SUMMARY OF THE INVENTION

An embodiment of the present invention provides an electronic device. The electronic device comprises a memory storing a program instruction and a central processing unit (CPU) comprising a first core and a second core. The computing power of the first core is higher than the computing power of the second core. The CPU is configured to read and execute the program instruction to implement a scheduler, a policy hint module, and an application. The CPU is further configured to calculate the required computing power of the first thread of the application. When the required computing power of the first thread is higher than the first threshold, the policy hint module is configured to transmit a message to the scheduler, and the message indicates that the first thread has to be allocated to the first core.

An embodiment of the present invention provides a method for scheduling threads, executed by an electronic device. The electronic device comprises a CPU and a memory storing a program instruction. The CPU comprises a first core and a second core, and the computing power of the first core is higher than the computing power of the second core. The CPU is configured to read and execute the program instruction to implement a scheduler, a policy hint module, and an application. The method comprises using the CPU to calculate the required computing power of the first thread of the application. The method further comprises using the policy hint module to transmit a message to the scheduler when the required computing power of the first thread is higher than the first threshold. The message indicates that the first thread has to be allocated to the first core.

### BRIEF DESCRIPTION OF THE DRAWINGS

The present invention can be more fully understood by reading the subsequent detailed description and examples with references made to the accompanying drawings, wherein:

FIG. 1A is the block diagram of the electronic device in accordance to the embodiments of the present disclosure;

FIG. 1B is a schematic diagram of the electronic device in accordance to the present disclosure;

FIG. 2 is a flow diagram of the method for scheduling threads in accordance to the embodiments of the present disclosure;

FIGS. 3A˜3C are flow diagrams of the method for scheduling threads taking the current load of the cores into consideration in accordance to the embodiments of the present disclosure;

FIG. 4 is the flow diagram of the method for scheduling threads in accordance to the embodiments of the present disclosure; and

FIG. 5 is the flow diagram of the method for scheduling threads in accordance to the embodiments of the present disclosure.

### DETAILED DESCRIPTION OF THE INVENTION

The following description is made for the purpose of illustrating the general principles of the invention and should not be taken in a limiting sense. The scope of the invention is best determined by reference to the appended claims.

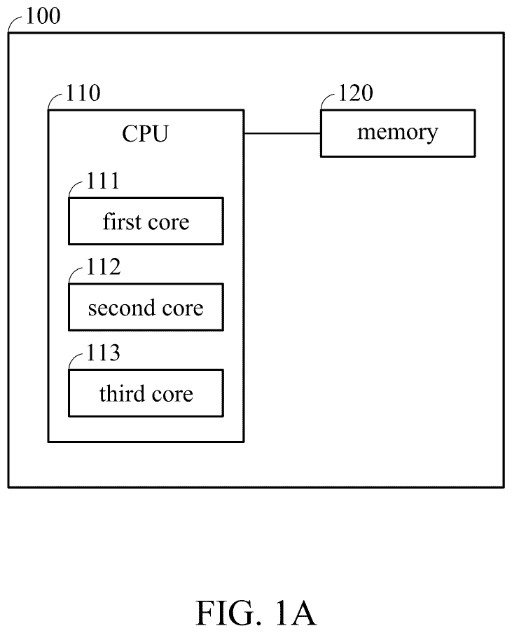

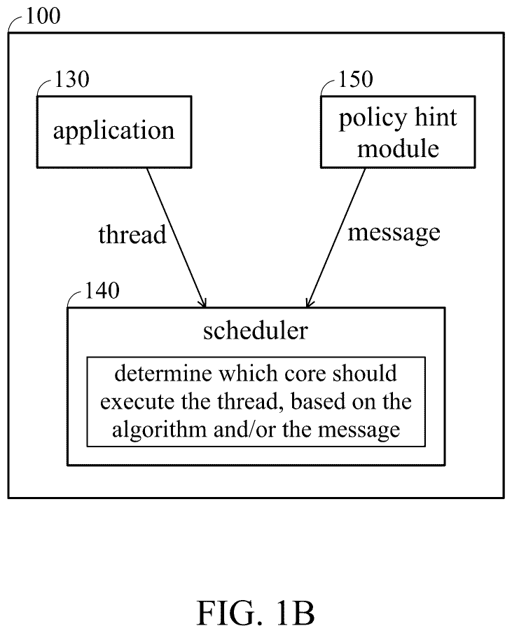

FIG. 1A is the block diagram of the electronic device 100 in accordance to the embodiments of the present disclosure. The electronic device 100 may perform various functions to implement processes and methods described herein. For example, the electronic device 100 may be a mobile device, a smartphone, a wearable device, a tablet computer, a notebook computer, or a desktop computer. The electronic device 100 may be implemented in the form of one or more integrated-circuit (IC) chips. The electronic device 100 comprises a central processing unit (CPU) 110 and a memory 120. The electronic device 100 may further comprise other components, such as a display panel, a battery, a transceiver, or a graphics processing unit (GPU).

The CPU 110 provides the required process and calculation capability to implement the method of the embodiments. For example, the CPU 110 may provide the process and calculation capability to perform operating systems, programs, software, modules, applications, and functions. In some embodiments, the CPU 110 may be implemented in the form of hardware with electronic components, such as transistors, diodes, capacitors, resistors, or inductors. These components are configured and arranged to achieve specific purposes in accordance with the embodiments of the present disclosure. The CPU 110 may comprise multiple cores. In some embodiments, the CPU 110 comprises the first core 111 and the second core 112. In some embodiments, the CPU 110 comprises the first core 111, the second core 112, and the third core 113. Computing power refers to the ability of a computer or a computing system to process data and perform calculations. It is a measure of the performance and efficiency of a computer in executing tasks, running applications, and solving complex problems.

The first core 111, the second core 112, and the third core 113 are different in the aspect of hardware configuration. The computing power of the first core 111 is higher than the computing power of the second core 112, and the computing power of the second core 112 is higher than the computing power of the third core 113. Specifically, different cores require different frequencies and power consumptions to achieve the same computing power and processing speed. The second core 112 requires higher frequency and power consumption to achieve the same computing power as the first core 111. Similarly, the third core 113 requires higher frequency and power consumption to achieve the same computing power as the second core 112.

The memory 120 stores data required by the CPU 110. The memory 120 may include non-volatile memories, such as read only memory (ROM), flash memory, hard disk drive, and solid-state disk. The memory 120 may also include volatile memories, such as dynamic random access memory (DRA M) and static random access memory (SRAM). In some embodiments, the memory 120 stores at least one program instruction, such as computer-readable instruction. When the program instruction is read and executed by the CPU 110, the program instruction causes the CPU 110 to implement software, modules, applications, functions, and methods according to the embodiments of the present disclosure.

FIG. 1B is a schematic diagram of the electronic device 100 in accordance to the present disclosure. In some embodiments, the CPU 110 is configured to implement an application 130, a scheduler 140, and a policy hint module 150. The application 130, the scheduler 140, and the policy hint module 150 are software modules or functions. The CPU 110 is configured to read and execute the program instruction stored in the memory 120 to implement the application 130, the scheduler 140, and the policy hint module 150. In other embodiments, the scheduler 140 and the policy hint module 150 may be implemented in the form of hardware modules, such as chips or integrated circuits.

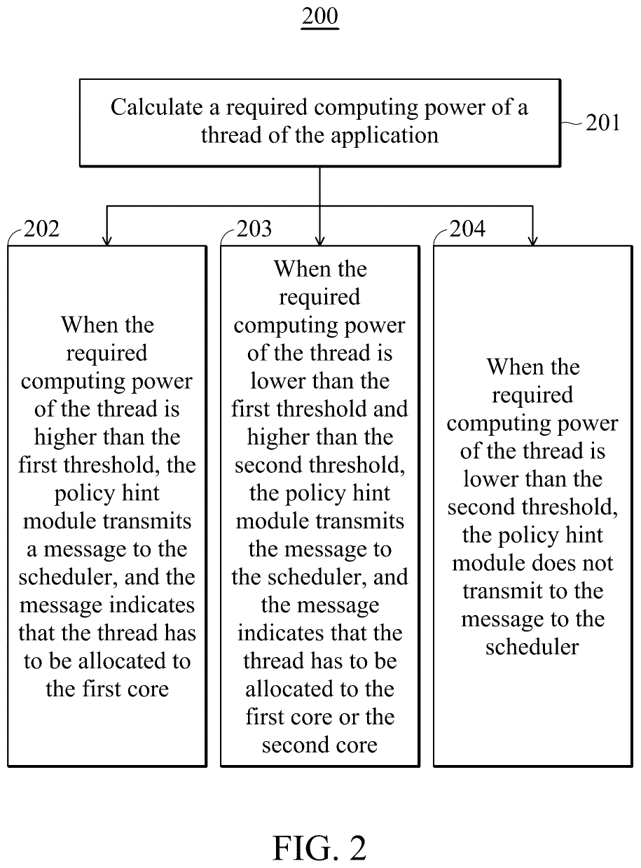

The application 130 may be, but not limited to, a game application, a live stream application, or a video application. The CPU 110 is configured to execute multiple threads of the application 130 to implement the application 130. The scheduler 140 is configured to assign the threads of the application 130 to one of the first core 111, the second core 112, and the third core 113 based on the known algorithms and/or the message received from the policy hint module 150. In other words, when there is a thread waiting to be executed, the scheduler 140 is configured to determine which core should execute the thread, based on, for example, an energy aware scheduling (EAS) based algorithm and/or the message received from the policy hint module 150. The detailed operation of the policy hint module 150 is described below referring to FIG. 2.

FIG. 2 is a flow diagram of the method 200 for scheduling threads in accordance to the embodiments of the present disclosure. The method 200 can be performed by the electronic device 100. In operation 201, the CPU 110 calculates the required computing power of a thread of the application 130. The required computing power of the thread indicates the expected computing power that the CPU 110 estimates the thread will consume, or the expected load that the CPU 110 estimates the thread will put on the CPU 110. In some embodiments, the CPU 110 is configured to calculate the required computing power of the thread based on the time duration it previously took the CPU 110 to execute the first thread, the previous power consumption, temperature, and frequency of the CPU 110 when the CPU 110 was executing the thread, and a latency requirement of the thread. In some embodiments, the CPU 110 records the time durations it took CPU 110 to execute the thread and the power consumption, the temperature, and the frequency of the CPU 110 when the CPU 110 was executing the thread. Then, the CPU 110 calculates the required computing power of the thread based on these recorded data. The CPU 110 is further configured to calculate the required computing power of the thread based on the latency requirement of the thread. The latency requirement of the thread indicates the latency of the thread has to be shorter than a certain time duration. For example, the latency requirement indicates that the thread has to be completed within the certain time duration. The latency requirement may be determined by the application 130. In some embodiments, the required computing power of the thread calculated by the CPU 110 is higher, when the time duration previously cost to execute the thread is longer, the previous power consumption, temperature, and frequency of the CPU 110 are higher, and the latency requirement of the thread is shorter. In some embodiments, the required computing power of the thread may be measured in capacity.

In operation 202, when the required computing power of the thread is higher than the first threshold, the policy hint module 150 is configured to transmit a message to the scheduler 140, and the message indicates that the thread has to be allocated to the first core 111. In operation 203, when the required computing power of the thread is lower than the first threshold and higher than the second threshold (which is lower than the first threshold), the policy hint module 150 is configured to transmit the message to the scheduler 140, and the message indicates that the thread has to be allocated to the first core 111 or the second core 112. In this case, the policy hint module 150 doesn't restrict the thread should be allocated to the first core 111 or the second core 112, and the scheduler 140 may determine which one of the first core 111 and the second core 112 should execute the thread based on its own algorithm. In operation 204, when the required computing power of the thread is lower than the second threshold, the policy hint module 150 is configured not to transmit the message to the scheduler 140. In this case, the policy hint module 150 doesn't indicate the scheduler 140 how to allocate the thread, and the scheduler 140 may determine which one of the first core 111, the second core 112, and the third core 113 should execute the thread based on its own algorithm.

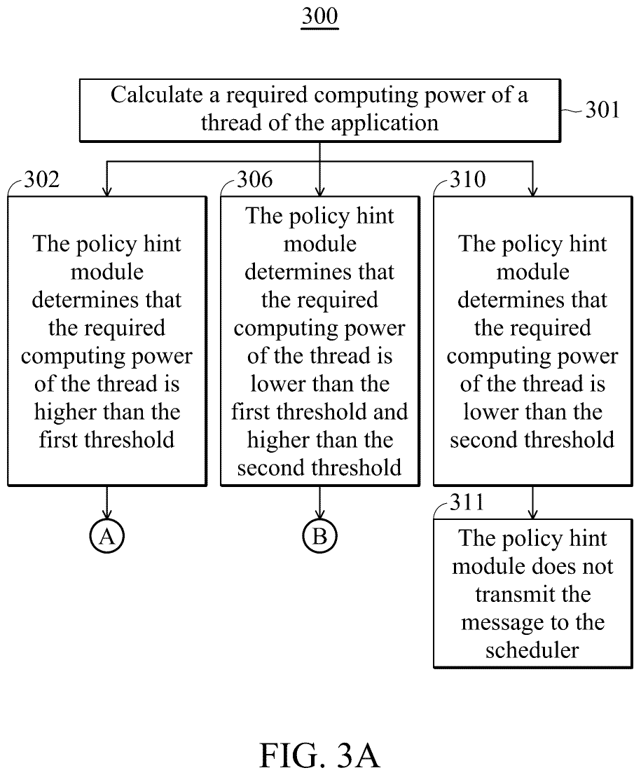

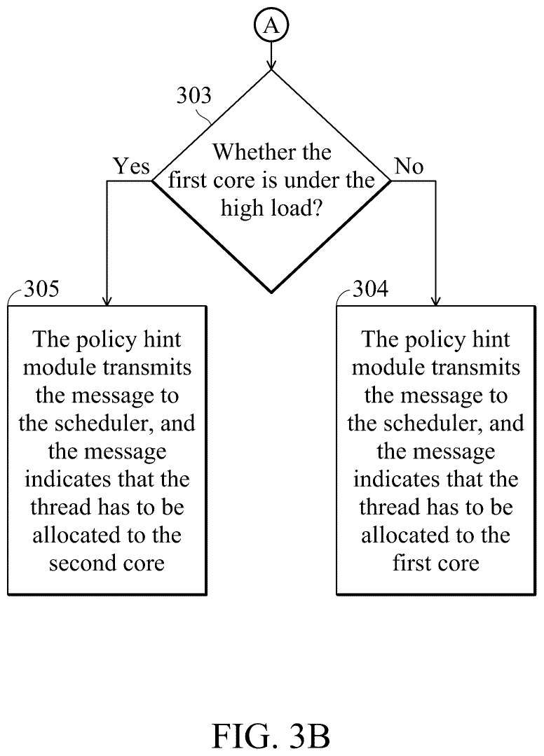

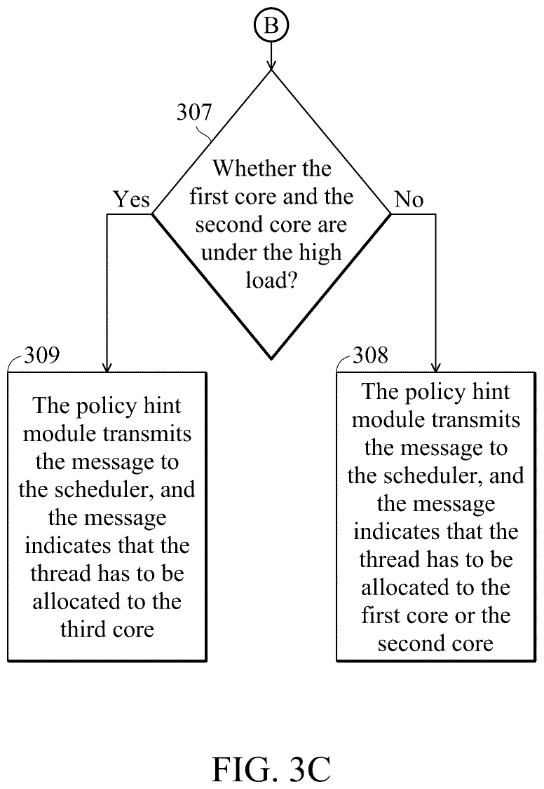

Refer to FIGS. 3A˜3C, FIGS. 3A˜3C are a flow diagram of the method 300 for scheduling threads taking the current load of the cores into consideration in accordance to the embodiments of the present disclosure. The method 300 can be performed by the electronic device 100. In operation 301, the CPU 110 calculates the required computing power of the thread of the application 130. In operation 302, the policy hint module 150 determines that the required computing power of the thread is higher than the first threshold. In operation 303, the policy hint module 150 determines whether the first core 111 is under the high load. Whether a core is under the high load is determined based on a proportion, which is the total load caused by all the threads currently being executed on the core over the maximum affordable load of the core (the maximum capability of the core). In other words, the proportion is the total computing power consumed by all the threads currently being executed on the core over the maximum computing power of the core. The total load of the core may be calculated by the scheduler 140 using the known method in the field. When the proportion is higher than a predetermined threshold, the policy hint module 150 determines that the core is under the high load. When the proportion is lower than the predetermined threshold, the policy hint module 150 determines that the core isn't under the high load. When the first core 111 isn't under the high load, the method 300 proceeds operation 304. When the first core 111 is under the high load, the method 300 proceeds operation 305.

In operation 304, similar to operation 202, the policy hint module 150 is configured to transmit the message to the scheduler 140, and the message indicates that the thread has to be allocated to the first core 111. In operation 305, the policy hint module 150 is configured to transmit the message to the scheduler 140, and the message indicates that the thread has to be allocated to the second core 112.

In operation 306, the policy hint module 150 determines that the required computing power of the thread is lower than the first threshold and higher than the second threshold. In operation 307, the policy hint module 150 determines whether the first core 111 and the second core 112 are under the high load. When the first core 111 and the second core 112 aren't under the high load, the method 300 proceeds operation 308. When the first core 111 and the second core 112 are under the high load, the method 300 proceeds operation 309. In operation 308, similar to operation 203, the policy hint module 150 is configured to transmit the message to the scheduler 140, and the message indicates that the thread has to be allocated to the first core 111 or the second core 112. In operation 309, the policy hint module 150 is configured to transmit the message to the scheduler 140, and the message indicates that the thread has to be allocated to the third core 113. In some embodiments, after operation 307, when the first core 111 is under the high load but the second core 112 isn't under the high load, the policy hint module 150 is configured to transmit the message to the scheduler 140, and the message indicates that the thread has to be allocated to the second core 112.

In operation 310, the policy hint module 150 determines that the required computing power of the thread is lower than the second threshold. In operation 311, similar to operation 204, the policy hint module 150 is configured not to transmit the message to the scheduler 140.

Thus, when the best core is under a high load, the policy hint module 150 is configured to indicate the scheduler 140 to allocate the thread to the second best core. This prevents threads from being allocated few resources and cores from being overloaded due to mandatory core assignments. In some embodiments, when the best core is under a high load, the policy hint module 150 is configured not to transmit the message to the scheduler 140.

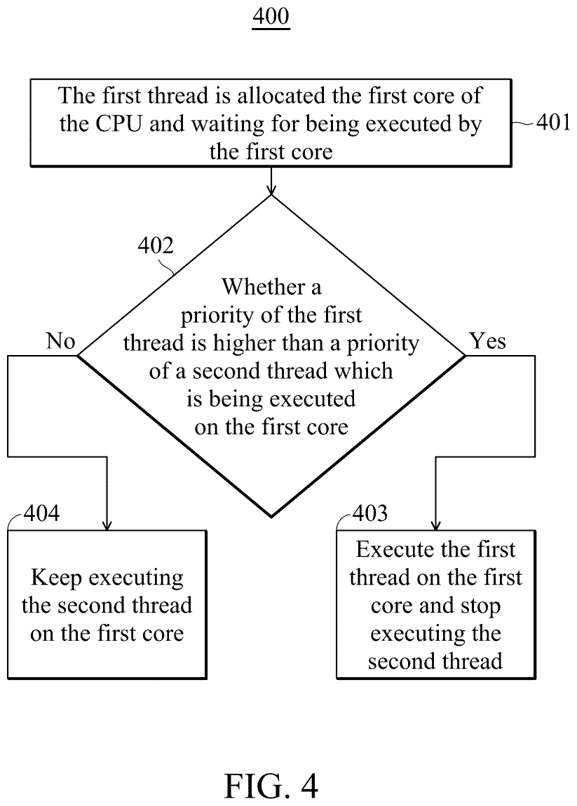

Refer to FIG. 4, FIG. 4 is the flow diagram of the method 400 for scheduling threads in accordance to the embodiments of the present disclosure. The method 400 can be performed by the electronic device 100. Furthermore, the method 400 may be performed after the first thread has been allocated to one of the first core 111, the second core 112, and the third core 113. For example, the method 400 may be performed after the method 200 or method 300 has been performed. In operation 401, the first thread is allocated to one of the cores of the CPU 110 and waiting for being executed by the core. The following takes the situation that the first thread is allocated to the first core 111 as example to illustrate method 400. For example, the first thread is allocated to the first core 111 and waiting for being executed by the first core 111 in a queue. In operation 402, the CPU 110 determines whether the priority of the first thread is higher than the priority of the second thread which is being executed on the first core 111. When the priority of the first thread is higher than the priority of the second thread, the method 400 proceeds to operation 403. When the priority of the first thread isn't higher than (lower than or equal to) the priority of the second thread, the method 400 proceeds to operation 404.

In operation 403, the CPU 110 executes the first thread on the first core 111 and stops executing the second thread. In operation 404, the CPU 110 keeps executing the second thread on the first core 111. In some embodiments, the threads related to drawing images have higher priority than the threads not related to drawing images. In some embodiments, the threads related to drawing images have the latency requirements, and the threads not related to drawing images do not have the latency requirements. That is to say, the threads with latency requirements have higher priority than the threads that do not have latency requirements. In some embodiments, the logic threads have the highest priority, the render threads have the second highest priority, other threads related to drawing images have the third highest priority (i.e. threads related to drawing images except for the logic threads and the render threads), and the threads not related to drawing images (e.g. background threads) have the lowest priority. The logic threads are the threads configured to determine the image going to be drawn (i.e. how the image going to be drawn looks like). For example, the logic threads determine the image going to be drawn based on the game logic of the application. The game logic determines the movement, the appearance and disappearance, the action, the shape, and the color of the objects in the image, how the objects in the image interact with each other, and so on. The render threads are configured to draw the image based on the instruction of the logic threads. In some embodiments, the render threads generate instructions and transmits these instructions to the GPU or application programming interface (API) based on the instruction of the logic threads, so as to control the GPU or API to draw the image. The render threads may also transmit the completed image to the CPU 110.

Thus, the CPU 110 will execute the thread with higher priority first. In this way, the CPU 110 makes sure that the latency requirement of the thread with high priority can be satisfied. Furthermore, if the thread with high priority waits for a long time, the core has to consume extensive resources in order to finish the thread in a short time to satisfy the latency requirement. Consume extensive resources will cause high frequency, high power consumption, and high temperature, which will negatively impact the user experience. Thus, method 400 can solve the above mentioned problem and improve the user experience.

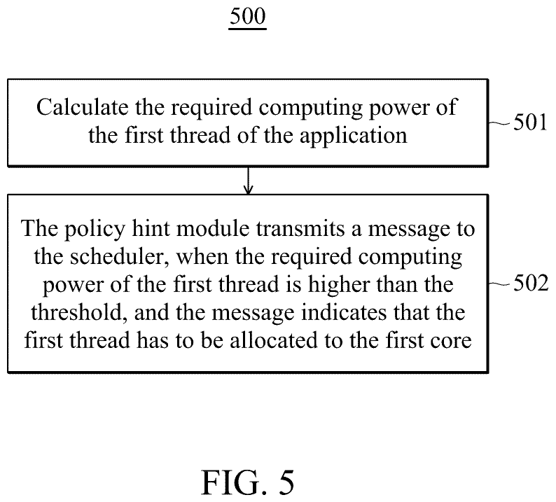

It is noted that the embodiments of the present disclosure may be applied to the electronic device comprising a CPU with at least two cores. Refer to FIG. 5, FIG. 5 is the flow diagram of the method 500 for scheduling threads in accordance to the embodiments of the present disclosure. Method 500 may be executed by an electronic device similar to the electronic device shown in FIG. 1. For example, method 500 is executed by an electronic device comprising a CPU (e.g. CPU 110) and a memory (e.g. memory 120) storing the program instruction. The CPU comprises the first core (e.g. the first core 111 or the second core 112) and the second core (e.g. the second core 112 or the third core 113), and the computing power of the first core is higher than the computing power of the second core. The CPU is configured to read and execute the program instruction to implement the application, the scheduler, and the policy hint module (similar to the application 130, the scheduler 140, and the policy hint module 150). In operation 501, the CPU calculates the required computing power of the first thread of the application. In operation 502, the policy hint module transmits a message to the scheduler, when the required computing power of the first thread is higher than the threshold (e.g. the first threshold or the second threshold). The message indicates that the first thread has to be allocated to the first core.

In some embodiments, method 500 further comprises the operation of not transmitting, the message to the scheduler via the policy hint module, when the required computing power of the first thread is lower than the threshold. In some embodiments, method 500 further comprises the operation of transmitting the message to the scheduler via the policy hint module, when the required computing power of the first thread is higher than the threshold and the first core is under a high load. The message indicates that the first thread has to be allocated to the second core. In other embodiments, the policy hint module is configured not to transmit the message to the scheduler, when the required computing power of the first thread is higher than the threshold and the first core is under a high load. In some embodiments, after the first thread has been allocated to one of the first core and the second core, method 500 further comprises the operation of determining a priority of the first thread is higher than a priority of a second thread which is being executed on the one of the first core and the second core using the CPU. Method 500 further comprises the operation of executing the first thread on the one of the first core and the second core and stop executing the second thread using the CPU. In some embodiments, the threads with latency requirements have higher priority than the threads that do not have latency requirements.

Embodiments of methods for scheduling threads and electronic devices which the methods are executed thereinto are provided. The methods and electronic devices of the present disclosure are able to automatically determine which core is suitable to execute the thread according to the information of the thread and the application and are adaptive to different applications and platforms. Furthermore, the methods and electronic devices of the present disclosure take the load of the cores into consideration while scheduling threads. Thus, the methods and electronic devices of the present disclosure are able to save the development resources and improve the user experience.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An electronic device, comprising:
a memory, storing a program instruction;
a central processing unit (CPU), comprising a first core and a second core, wherein a computing power of the first core is higher than a computing power of the second core;
wherein the CPU is configured to read and execute the program instruction to implement a scheduler, a policy hint module, and an application;
wherein the CPU is configured to calculate a required computing power of a first thread of the application;
wherein when the required computing power of the first thread is higher than a first threshold, the policy hint module is configured to transmit a message to the scheduler, and the message indicates that the first thread has to be allocated to the first core.

2. The electronic device as claimed in claim 1, wherein when the required computing power of the first thread is lower than the first threshold, the policy hint module is configured not to transmit the message to the scheduler.

3. The electronic device as claimed in claim 1, wherein when the required computing power of the first thread is higher than the first threshold and the first core is under a high load, the policy hint module is configured to transmit the message to the scheduler, and the message indicates that the first thread has to be allocated to the second core.

4. The electronic device as claimed in claim 1, wherein the CPU further comprises a third core, and a computing power of the third core is lower than the computing power of the second core;
wherein when the required computing power of the first thread is lower than the first threshold and higher than a second threshold, the policy hint module is configured to transmit the message to the scheduler, and the message indicates that the first thread has to be allocated to the first core or the second core;
wherein when the required computing power of the first thread is lower than the second threshold, the policy hint module is configured not to transmit the message to the scheduler.

5. The electronic device as claimed in claim 4, when the required computing power of the first thread is lower than the first threshold and higher than a second threshold and the first core is under a high load, the policy hint module is configured to transmit the message to the scheduler, and the message indicates that the first thread has to be allocated to the second core.

6. The electronic device as claimed in claim 1, wherein the CPU is configured to calculate the required computing power of the first thread based on a time duration it previously took the CPU to execute the first thread, the previous power consumption, temperature, and frequency of the CPU when the CPU was executing the first thread, and a latency requirement of the first thread.

7. The electronic device as claimed in claim 1, wherein after the first thread has been allocated to one of the first core and the second core, the CPU is further configured to:
determine a priority of the first thread is higher than a priority of a second thread which is being executed on the one of the first core and the second core; and
execute the first thread on the one of the first core and the second core and stop executing the second thread.

8. The electronic device as claimed in claim 7, wherein the threads with latency requirements have higher priority than the threads that do not have latency requirements.

9. A method for scheduling threads, executed by an electronic device comprising a central processing unit (CPU) and a memory storing a program instruction, wherein the CPU comprises a first core and a second core, and a computing power of the first core is higher than a computing power of the second core, wherein the CPU is configured to read and execute the program instruction to implement a scheduler, a policy hint module, and an application, wherein the method comprises:
calculating, via the CPU, a required computing power of a first thread of the application;
transmitting, via the policy hint module, a message to the scheduler, when the required computing power of the first thread is higher than a first threshold, wherein the message indicates that the first thread has to be allocated to the first core.

10. The method as claimed in claim 9, further comprising:
not transmitting, via the policy hint module, the message to the scheduler, when the required computing power of the first thread is lower than the first threshold.

11. The method as claimed in claim 9, further comprising:
transmitting, via the policy hint module, the message to the scheduler, when the required computing power of the first thread is higher than the first threshold and the first core is under a high load, wherein the message indicates that the first thread has to be allocated to the second core.

12. The method as claimed in claim 9, wherein the CPU further comprises a third core, and a computing power of the third core is lower than the computing power of the second core, wherein the method further comprises:
transmitting, via the policy hint module, the message to the scheduler, when the required computing power of the first thread is lower than the first threshold and higher than a second threshold, wherein the message indicates that the first thread has to be allocated to the first core or the second core;
not transmitting, via the policy hint module, the message to the scheduler, when the required computing power of the first thread is lower than the second threshold.

13. The method as claimed in claim 12, further comprising:
transmitting, via the policy hint module, the message to the scheduler, when the required computing power of the first thread is lower than the first threshold and higher than a second threshold and the first core is under a high load, wherein the message indicates that the first thread has to be allocated to the second core.

14. The method as claimed in claim 9, further comprising:
calculating, via the CPU, the required computing power of the first thread based on based on a time duration it previously took the CPU to execute the first thread, the previous power consumption, temperature, and
frequency of the CPU when the CPU was executing the first thread, and a latency requirement of the first thread.

15. The method as claimed in claim 9, wherein after the first thread has been allocated to one of the first core and the second core, the method further comprises:
determining, via the CPU, a priority of the first thread is higher than a priority of a second thread which is being executed on the one of the first core and the second core; and
executing, via the CPU, the first thread on the one of the first core and the second core and stop executing the second thread.

16. The method as claimed in claim 15, wherein the threads with latency requirements have higher priority than the threads that do not have latency requirements.
